(19) United States
(12) Patent Application Publication
(10) Pub. No.: US 2007/0002124 A1
(43) Pub. Date: Jan. 4, 2007

(54) METHOD FOR RECORDING IMAGE ONTO LABEL LAYER OF OPTICAL DISC

(76) Inventors: William Wang, Taoyuan (TW); Meug-Shin Yen, Taoyuan (TW); Hank Yang, Taoyuan (TW); Ta-Yuan Lee, Taoyuan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/426,390

(22) Filed: Jun. 26, 2006

(30) Foreign Application Priority Data
Jun. 29, 2005 (TW) 094121828

(51) Int. Cl. B41J 2/435

(52) U.S. Cl. 347/224

(57) ABSTRACT

The present invention provides a method for recording an image onto a label layer of an optical disc by a laser beam. First, the method of the invention divides the label layer into a plurality of unit regions. For each of the unit regions, the method of the invention determines a recording pattern corresponding to each unit region in accordance with the data related to the image to be recorded. Finally, the method of the invention controls the laser beam to irradiate a relative energy on each unit region, so as to form the corresponding recording pattern. Thereby, the whole of the recording patterns formed on the label layer exhibits the image.

### BACKGROUND OF THE INVENTION

1. Field of the Invention

The present invention relates generally to optical disc labeling and, more particularly, to a method for recording an image onto a label layer of an optical disc.

2. Description of the Prior Art

As the recordable optical discs, such as a CD-R (compact disk recordable) and a CD-RW (compact disk rewritable), have been extensively used for recording a large amount of information, the accompanying issue is the management of optical discs that have already recorded data. Methods for labeling the non-data side of such optical discs with text and figures, for example, have continued to develop as consumers desire more convenient ways to identify the data they've burned onto their own CDs. Generally, methods for labeling an optical disc include physically writing on the non-data side with a permanent marker (e.g. a sharpie marker) or printing out a paper sticker label and sticking it onto the non-data side of the disc. Other physical marking methods developed for implementation in conventional CD drives include ink-jet printing, thermal wax transfer, and thermal dye transfer methods.

In recent years, there has been a proposed technology, as disclosed in U.S. Pat. No. 6,864,907, in which a label layer that changes its color in response to heat or light is integrally provided with an optical disc; the label layer is provided on a label face opposite to the recording face to draw images in order to indicate the contents recorded on the optical disc. The label face is set to face an optical pickup, and a laser beam is radiated by the optical pickup to cause the label layer to change its color, so as to form a visible image.

The related prior art includes an approach disclosed in U.S. patent application Ser. No. 10/447736, which aims to form an image onto the label layer by vibrating a laser beam under focus control. The image data is a group of gradation data that defines the density of the dots to be drawn on the discoid optical disc. The individual dots are arranged in positions corresponding to the intersections of the concentric circles of the optical disc and the radial lines extending from the center. Referring to FIG. 1, the approach involves vibrating the laser beam in the radial direction, such that the irradiation trajectory of the laser beam differs in each round. Hence, the area ratio of a colored portion and an uncolored portion in a dot is changed by conducting control such that the label layer is colored by radiating a laser beam in a certain round, while the label layer is not colored in another round, thus making it possible to display the variation in different densities. FIG. 2 is an illustration showing various patterns displaying the image data of 8-gradation. To display an image of 8 gradations, however, it is necessary to take seven rounds of spinning the optical disc to complete the coloring of one dot. Though the approach also proposes a quick mode to reduce the time required for forming an image, it lowers the resolution of the image to 2 gradations.

Accordingly, one scope of the invention is to provide a method that is simple and efficient to form an image onto a label layer provided on an optical disc, which changes its color in response to light or heat of a laser beam. Another scope of the invention is to provide a method for forming high quality and high resolution images onto a label layer of an optical disc.

### SUMMARY OF THE INVENTION

According to a first preferred embodiment of the invention, a method is provided for recording an image onto a label layer of an optical disc by a laser beam. The recording method, according to the invention, first divides the label layer into a plurality of unit regions. For each of the unit regions, a corresponding recording pattern is determined in accordance with the data related to the image to be recorded. The ratio of the recording pattern corresponding to a specific unit region is determined in accordance with a gradation defined by the image data. Finally, the recording method according to the invention controls the laser beam to irradiate a relative energy on the unit region, so as to form the corresponding recording pattern. Thereby, the whole of the recording patterns formed on the label layer exhibits the image.

According to a second preferred embodiment of the invention, a method is provided for recording an image onto a label layer of an optical disc by a laser beam. The recording method, according to the invention, first divides the image into a plurality of imaging units. Each of the imaging units defines a gradation and corresponds to a respective imaging position on the label layer. Next, a recording pattern is determined for each imaging unit. The area of the recording pattern corresponding to a specific imaging unit is determined in accordance with the gradation of the imaging unit. Finally, the recording method according to the invention controls the laser beam to irradiate a relative energy at the imaging position corresponding to a specific imaging unit, so as to form the corresponding recording pattern. Thereby, the whole of the recording patterns formed on the label layer exhibits the image.

The advantage and spirit of the invention may be understood by the following recitations together with the appended drawings.

### BRIEF DESCRIPTION OF THE APPENDED DRAWINGS

FIG. 1 is a diagram showing a laser beam irradiation trajectory caused by vibrating the laser beam in the radial direction of an optical disc.

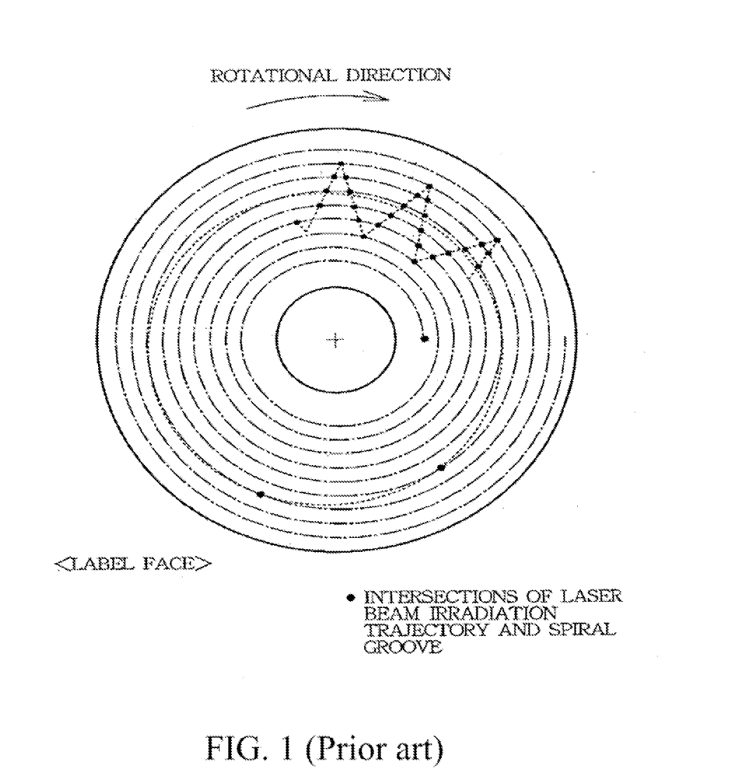

FIG. 2 is an illustration showing various patterns displaying the image data of 8-gradation.

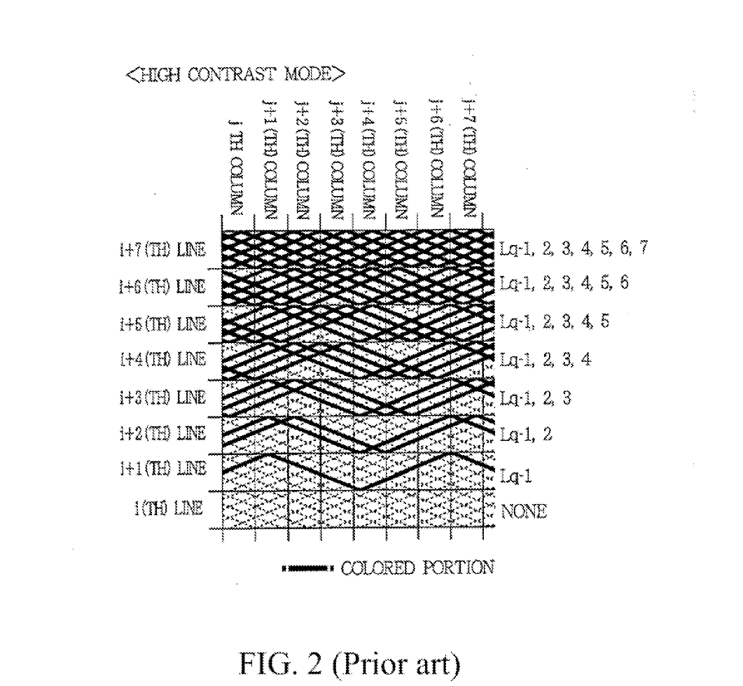

FIG. 3 is a sectional view showing a construction of an optical disc according to a preferred embodiment of the invention.

FIG. 4 illustrates an exemplary table summarizing the 3-bit gradation data and the corresponding recording patterns according to one embodiment of the invention.

FIG. 5 is a diagram showing the step of dividing the label layer into a plurality of unit regions according to one embodiment of the invention.

FIG. 6 is a flowchart showing a method for recording an image onto a label layer of an optical disc by a laser beam in accordance with a first preferred embodiment of the invention.

FIG. 7 depicts an embodiment showing an exemplary image formed on the label layer of the optical disc.

FIG. 8 depicts another embodiment showing an exemplary image formed on the label layer of the optical disc.

FIG. 9 depicts another embodiment showing an exemplary image formed on the label layer of the optical disc.

FIG. 10 depicts another embodiment showing an exemplary image formed on the label layer of the optical disc.

FIG. 11 is a flowchart showing a method for recording an image onto a label layer of an optical disc by a laser beam in accordance with a second preferred embodiment of the invention.

### DETAILED DESCRIPTION OF THE INVENTION

The present invention provides a method for recording an image onto a label layer of an optical disc by a laser beam. Several preferred embodiments according to the invention will be disclosed hereinafter.

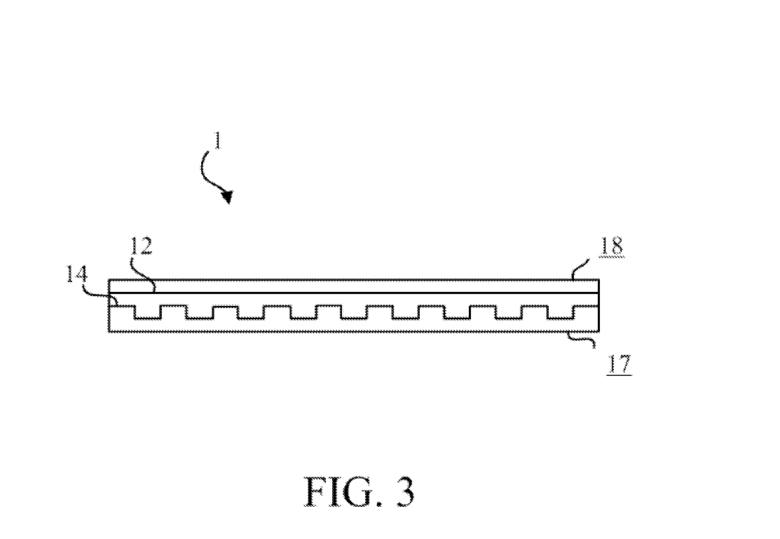

Referring to FIG. 3, FIG. 3 is a sectional view showing a construction of an optical disc 1 according to a preferred embodiment of the invention. As shown in FIG. 3, the optical disc 1 has a recording face 17 and a labeling face 18 opposite to the recording face 17. The optical disc 1 includes a label layer 12 which is configured to change its color to form an image in response to heat or light of a laser beam. The image formed on the label layer 12 is represented in a group of primitive recording patterns, such as dots or lines. In this embodiment, the label layer 12 may be formed on the labeling face 18 or near the labeling face 18 by depositing special chemical coating during the manufacture of optical discs. It should be noted that FIG. 3 only shows the later case. The optical disc 1 also includes a data layer 14 on which a plurality of predetermined address codes are marked. In practical applications, the predetermined address codes marked on the data layer 14 are Absolute Time In Pregroove (ATIP) codes.

In one embodiment, to form an image, the optical disc 1 is set with its labeling face 18 opposite to an optical pick-up unit of an optical disc drive, which is used for irradiating a laser beam on the label layer 12. The image data are received to determine the recording patterns to be formed on the label layer 12, as will be described in more detail later. In practical applications, the received image data are supplied by a host and are temporarily stored in a buffer of the optical disc drive.

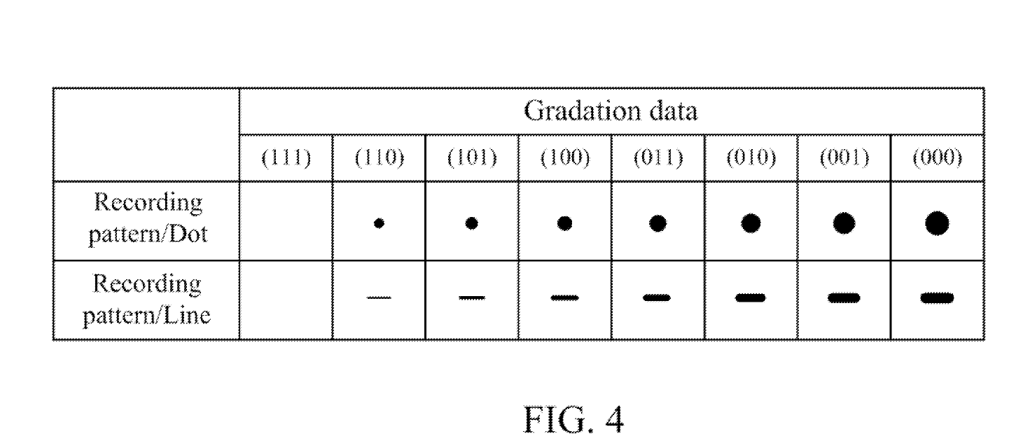

The major difference between the prior art and the present invention is that the image formed on the label layer 12 of the optical disc 1 is composed of a plurality of recording patterns, each of which has a respective colored area so as to exhibit the gradations of color. It is assumed that the image is to be formed in eight gradations per recording pattern, and the gradation data of each recording pattern takes 3-bit to represent various gradations of the recording patterns. To be more specific, among the 3-bit gradation data, (111) specifies the brightest (high) gradation, and the gradation grows darker (lower) in the order of (110), (101), (100), (011), (010), (001) and (000). FIG. 4 illustrates an exemplary table summarizing the 3-bit gradation data and the corresponding recording patterns according to one embodiment of the invention. In one embodiment, the recording patterns may be formed as dots or lines with various sizes or widths. To this end, the laser beam irradiated by the optical pick-up unit is focused on the label layer 12 to form a dot. Alternately, the optical pick-up unit is moved transversely to draw a line on the label layer 12. To vary the dot size or line width formed on the label layer 12, the power of the laser beam and/or the irradiation time of the laser beam may be adjusted to modulate the accumulated thermal or light energy irradiated on the label layer 12, so as to form dots or lines with various sizes or widths. It should be noted that the present invention is obviously suitable for forming images of wider variety of gradations, but not restricted to 8-gradation images.

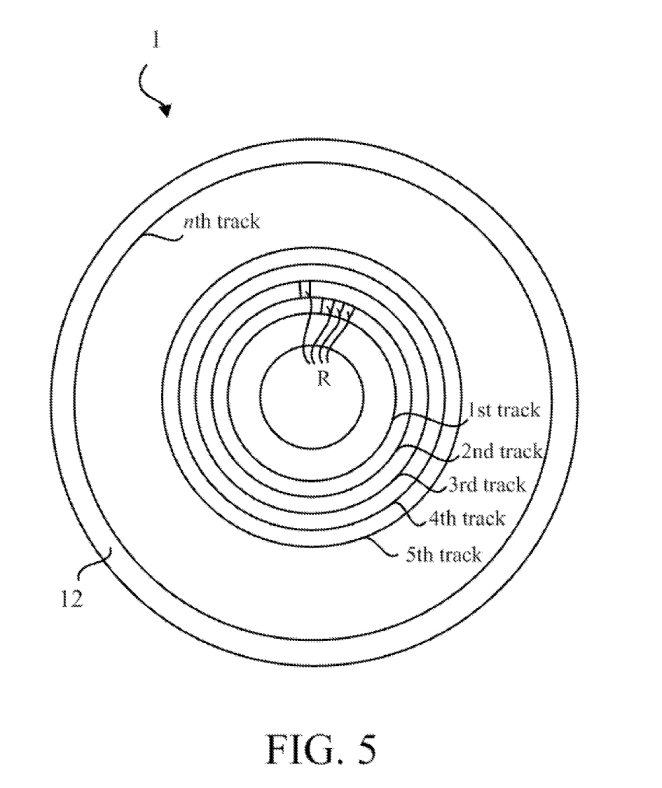

According to a first preferred embodiment of the invention, to form the recording patterns individually on the label layer 12, a plurality of primitive coloring area is first defined on the label layer 12 of the optical disc 1. As shown in FIG. 5, n tracks which are concentric to the center of the optical disc 1 are defined on the label layer 12. Each track is further divided into a plurality of unit regions R with equivalent area. In one embodiment, the image formed on the label layer 12 is composed of a plurality of colored unit regions R indicated by a set of gradation data. Recording patterns having various areas are formed in the unit regions R to display the gradations of color. By varying the ratio of colored area to uncolored area within a unit region R, it is thus possible to show a specific gradation of color in the unit region R. In one embodiment, as shown in FIG. 4, the data value of the darkest gradation, i.e. (000), corresponds to a recording pattern with a predetermined area. In practical applications, the label layer 12 is divided into the unit regions based on the predetermined area. More specifically, the area of each unit region R should be large enough to form at least one recording pattern with the predetermined area.

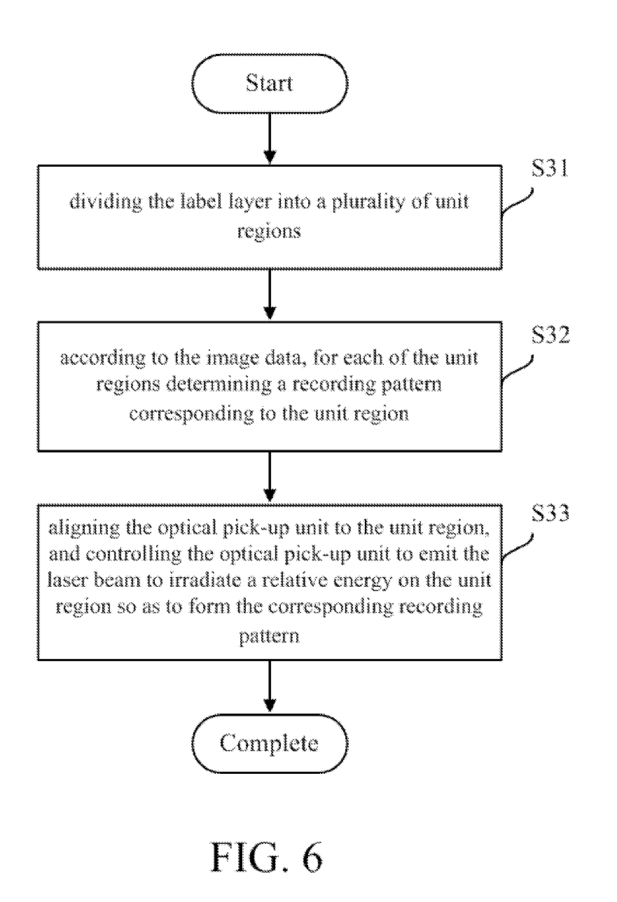

FIG. 6 is a flowchart showing a method for recording an image onto a label layer of an optical disc by a laser beam emitted by an optical pick-up unit according to a first preferred embodiment of the invention. First, step S31 is performed to divide the label layer 12 into a plurality of unit regions R. For each of the unit regions R, a corresponding recording pattern is determined in accordance with the data related to the image (step S32). The ratio of the recording pattern corresponding to a specific unit region R is determined in accordance with a gradation defined by the image data. Finally, step S33 is performed to align the optical pick-up unit to a unit region R. The optical pick-up unit is then controlled to emit a laser beam to irradiate a relative energy on the unit region R, so as to form the corresponding recording pattern. Thereby, the whole of the recording patterns formed on the label layer 12 exhibits the image.

In one embodiment, the label layer 12 has a color changeable in response to thermal or light energy of a laser beam, and step S33 is performed by irradiating each of the unit regions R with the laser beam to form the corresponding recording pattern on the label layer 12. The power of the laser beam and/or the irradiation time of the laser beam can be adjusted, so as to fit the thermal or light energy irradiated by the laser beam on each of the unit regions R to the relative energy for forming the corresponding recording pattern.

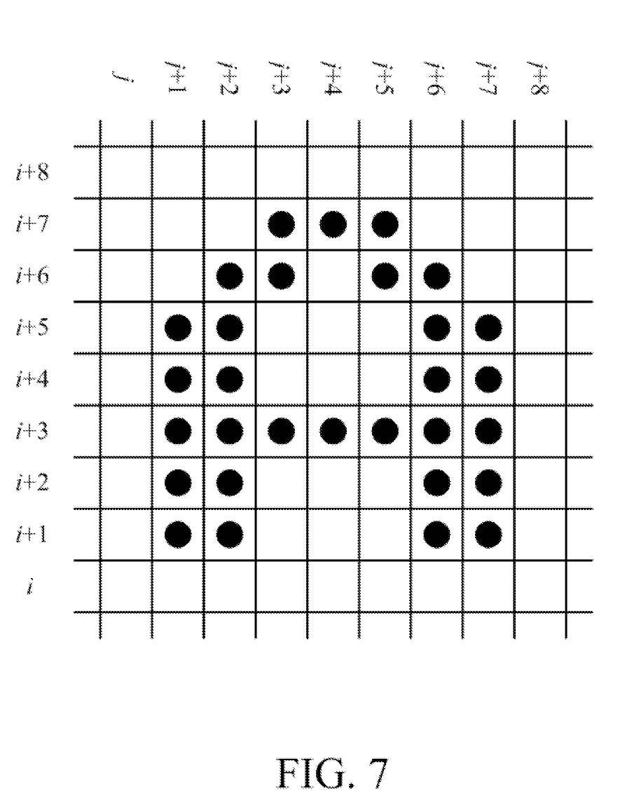

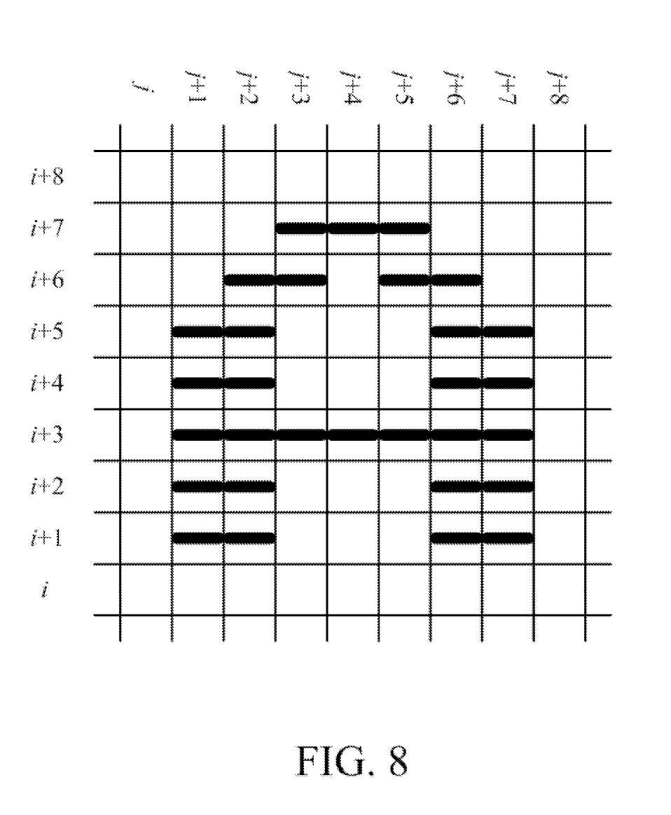

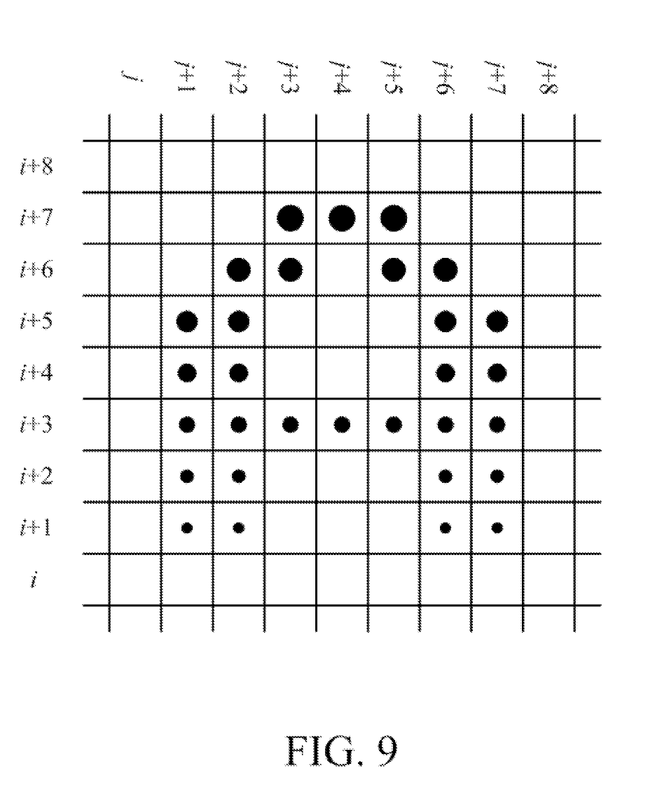

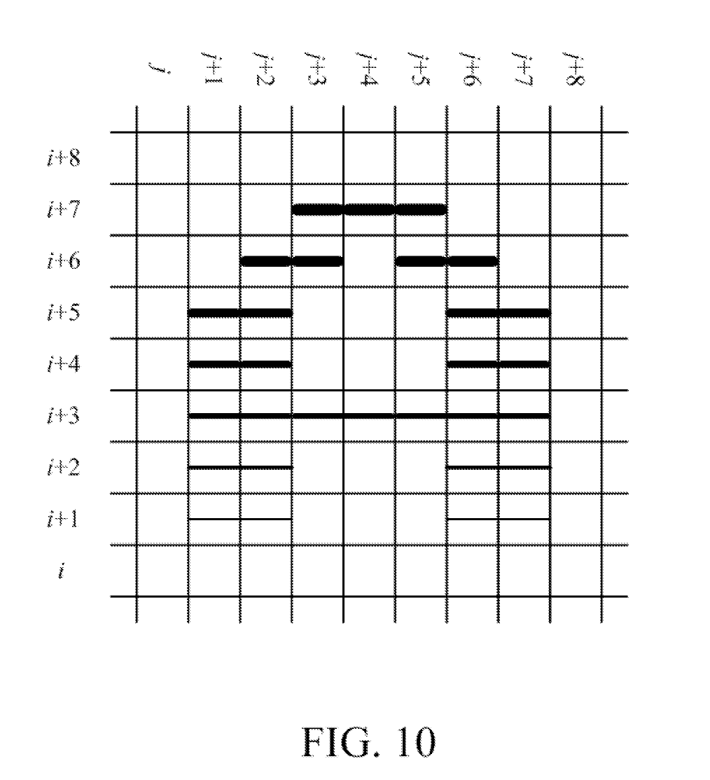

FIGS. 7 through 10 depict several embodiments showing an exemplary image (capital character A), which is composed of a plurality of colored unit regions formed on the label layer 12 of the optical disc 1. From FIGS. 7 to 10, i is an integer index ranging from 1 to n, and j is another integer index indicating a unit region on a specific track. The image may be a monochromic image, as shown in FIGS. 7 and 8, composed of colored unit regions with equivalent dot size or line width. The image may also exhibits the gradations of color through colored unit regions with various dot sizes or line widths, as shown in FIGS. 9 and 10.

In one embodiment, when the gradation data of a unit region, e.g. Ri+7,j+3 shown in FIGS. 7 through 10, is received, a recording pattern corresponding to the unit region can be determined. In this example, the gradation data of Ri+7,j+3 is (000), and a dot or line with specific size or width can be determined accordingly (as those in the entries corresponding to gradation data (000) of the table shown in FIG. 4). The optical disc 1 is rotated, and the optical pick-up unit is moved to Ri+7,j+3 to form the determined dot or line. The optical pick-up unit is controlled to emit a laser beam, and the location of the object lens is adjusted to focus the laser beam on Ri+7,j+3. As a result, the area of Ri+7,j+3 irradiated by the laser beam changes its color in response to heat or light of the laser beam. By varying the power of the laser beam and/or the rotation speed of the optical disc (resulting in different irradiation times of laser beam), the thermal or light energy irradiated by the laser beam on Ri+7,j+3 is modulated to fit to necessary energy for forming the determined dot or line.

In practical applications, unit regions having equivalent gradation data may be batch processed to avoid the frequent switching between various dot sizes and line widths. In order to avoid distortion, the layout of the unit regions exhibiting the image must be converted into the coordinate system shown in FIG. 5.

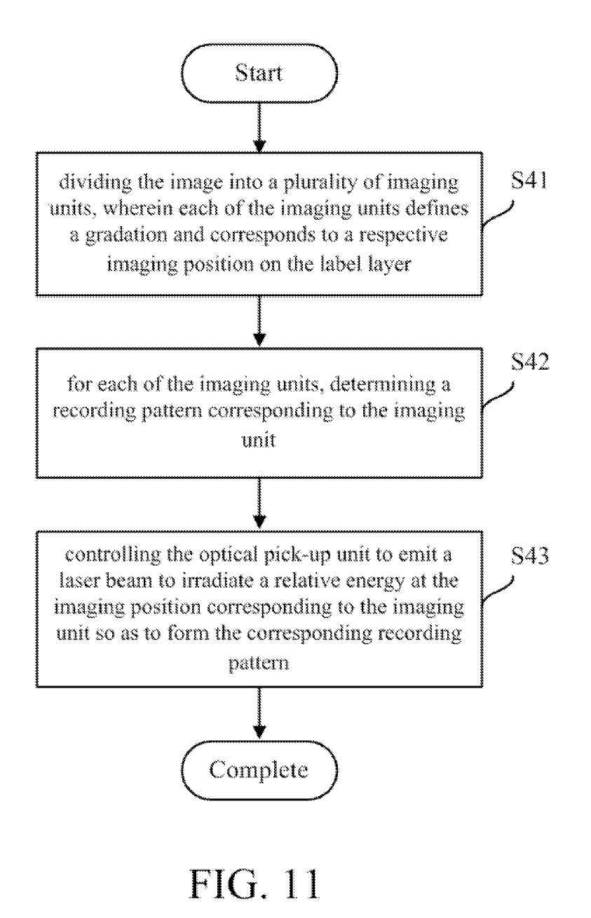

FIG. 11 is a flowchart showing a method for recording an image onto a label layer of an optical disc by a laser beam emitted by an optical pick-up unit according to a second preferred embodiment of the invention. First, step S41 is performed to divide the image into a plurality of imaging units. Each of the imaging units defines a gradation and corresponds to a respective imaging position on the label layer 12. Next, a recording pattern is determined to correspond with each imaging unit (step S42). The area of the recording pattern corresponding to a specific imaging unit is determined in accordance with the gradation of the imaging unit. Finally, step S43 is performed to control the optical pick-up unit to emit a laser beam to irradiate a relative energy at the imaging position corresponding to a specific imaging unit, so as to form the corresponding recording pattern. Thereby, the whole of the recording patterns formed on the label layer 12 exhibits the image.

In one embodiment, the label layer 12 has a color changeable in response to thermal or light energy of a laser beam, and step S43 is performed by irradiating the imaging positions with the laser beam to form the corresponding recording patterns on the label layer 12. The power of the laser beam and/or the irradiation time of the laser beam can be adjusted, so as to fit the thermal or light energy irradiated by the laser beam at each of the imaging positions to the relative energy for forming the corresponding recording pattern. In one embodiment, step S41 further includes the operation of dividing the label layer 12 into a plurality of unit regions. Each of the unit regions corresponds to a respective imaging position.

In one embodiment, when the gradation data of an imaging unit is received, e.g. (000), a recording pattern corresponding to the imaging unit is determined. According to the gradation data of (000), a dot or line with specific size or width may be determined (as those in the entries corresponding to gradation data (000) of the table shown in FIG. 4). The optical disc 1 is rotated, and the optical pick-up unit is moved to an imaging position (or unit region) corresponding to the imaging unit to form the determined dot or line. The optical pick-up unit is controlled to emit a laser beam, and the location of the object lens is adjusted to focus the laser beam on the imaging position (or unit region). As a result, the area of the imaging position (or unit region) irradiated by the laser beam changes its color in response to the heat or light of the laser beam. By varying the power of the laser beam and/or the rotation speed of optical disc (resulting in different irradiation times of laser beam), the thermal or light energy irradiated by the laser beam on the imaging position (or unit region) is modulated to fit to necessary energy for forming the determined dot or line. With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for recording an image onto a label layer of an optical disc by a laser beam, said method comprising the steps of:
(a) dividing the label layer into a plurality of unit regions;
(b) according to the data related to the image, for each of the unit regions determining a recording pattern corresponding to said one unit region, wherein the ratio of the recording pattern to said one unit region is determined in accordance with a gradation defined by the image data; and
(c) controlling the laser beam to irradiate a relative energy on said one unit region so as to form the corresponding recording pattern;
whereby the whole of the recording patterns formed on the label layer exhibits the image.

2. The method of claim 1, wherein the area of each formed recording pattern is limited within a predetermined area.

3. The method of claim 2, wherein the label layer is divided into the unit regions based on the predetermined area.

4. The method of claim 1, wherein the label layer has a color changeable in response to thermal or light energy of the laser beam, and step (c) is performed by irradiating each of the unit regions with the laser beam to form the corresponding recording pattern on the label layer.

5. The method of claim 4, wherein the power of the laser beam and/or the irradiation time of the laser beam is adjusted so as to fit the thermal or light energy irradiated by the laser beam on each of the unit regions to the relative energy for forming the corresponding recording pattern.

6. A method for recording an image onto a label layer of an optical disc by a laser beam, said method comprising the steps of:
(a) dividing the image into a plurality of imaging units, wherein each of the imaging units defines a gradation and corresponds to a respective imaging position on the label layer;
(b) for each of the imaging units, determining a recording pattern corresponding to said one imaging unit, wherein the area of the recording pattern is determined in accordance with the gradation of said one imaging unit; and
(c) controlling the laser beam to irradiate a relative energy at the imaging position corresponding to said one imaging unit so as to form the corresponding recording pattern;
whereby the whole of the recording patterns formed on the label layer exhibits the image.

7. The method of claim 6, wherein the label layer has a color changeable in response to thermal or light energy of the laser beam, and step (c) is performed by irradiating the imaging positions with the laser beam to form the corresponding recording patterns on the label layer.

8. The method of claim 7, wherein the power of the laser beam and/or the irradiation time of the laser beam is adjusted so as to fit the thermal or light energy irradiated by the laser beam at each of the imaging positions to the relative energy for forming the corresponding recording pattern.

9. The method of claim 7, wherein step (a) further comprises:
dividing the label layer into a plurality of unit regions, wherein each of the unit regions corresponds to the respective imaging position.
